(19) United States
(12) Patent Application Publication
(10) Pub. No.: US 2003/0136368 A1
(43) Pub. Date: Jul. 24, 2003

(54) Intake manifold for an internal combustion engine provided with exhaust gas recycling

(75) Inventors: Francesco Paolo Ausiello, Bologna (IT); Maurizio Xella, Bologna (IT); Marco Bovina, Pieve di Cento (IT)

Correspondence Address: CHAPMAN AND CUTLER, 111 WEST MONROE STREET, CHICAGO, IL, 60603, US

(73) Assignee: MAGNETI MARELLI POWERTRAIN, S.p.A., Torino (IT)

(21) Appl. No.: 10/316,415

(22) Filed: Dec. 11, 2002

(30) Foreign Application Priority Data
Dec. 14, 2001 (IT) BO2001A 000761

(51) Int. Cl. F02M 35/10; F02M 25/07

(52) U.S. Cl. 123/184.21; 123/184.42; 123/568.12

(57) ABSTRACT

An intake manifold for an internal combustion engine provided with exhaust gas recycling; the intake manifold comprises a tubular member having an inner chamber and has a plurality of intake ducts which extend parallel to and equally spaced from one another from the lateral surface of the tubular member in order to bring the inner chamber into communication with respective cylinders; a support body physically independent from the tubular member houses a recycling duct and is mechanically connected to the tubular member so as to be disposed in the space bounded at the bottom by the intake ducts and laterally by the tubular member.

The present invention relates to an intake manifold for an internal combustion engine provided with exhaust gas recycling.

### BACKGROUND OF THE INVENTION

An internal combustion engine provided with exhaust gas recycling normally comprises a plurality of cylinders (typically four in line), each of which is connected to an intake manifold by at least one respective intake valve and to an exhaust manifold by at least one respective exhaust valve.

The intake manifold is connected to a filter device in order to receive fresh air (i.e. air from the external atmosphere containing approximately 20% oxygen) and is connected to the exhaust manifold via a recycling duct regulated by a recycling valve in order to receive a predetermined quantity of the gases contained in the exhaust manifold and generated by prior combustion in the cylinders.

In order not to decrease the volumetric efficiency of the engine, the recycled exhaust gases are cooled by a heat exchanger coupled to the recycling duct before they are introduced into the intake manifold. Moreover, in order to try to estimate the quantity of recycled exhaust gas, a sensor adapted to detect the flow of gases in the recycling duct may be coupled to the recycling duct.

### SUMMARY OF THE INVENTION

The object of the present invention is to provide an intake manifold for an internal combustion engine provided with exhaust gas recycling, which is easy and economic to embody, and is in particular very easy to assemble, is of relatively small bulk and enables high-precision measurement of the flow of recycled exhaust gases.

The present invention therefore relates to an intake manifold for an internal combustion engine provided with exhaust gas recycling as set out in claim 1.

### BRIEF DESCRIPTION OF THE DRAWINGS

The present invention will be described below with reference to the accompanying drawings, which show a number of non-limiting embodiments thereof and in which:

FIG. 1 is a diagrammatic and perspective view of an intake manifold of the present invention;

FIG. 2 shows a detail of FIG. 1 in cross section and on an enlarged scale;

FIG. 3 is a diagrammatic and perspective view of a further embodiment of the intake manifold of FIG.

### DETAILED DESCRIPTION OF THE INVENTION

In the accompanying drawings, reference numeral 1 designates an intake manifold forming part of an internal combustion engine (known overall and not shown) provided with four cylinders, each of which is connected to the intake manifold 1 by at least one respective intake valve and to an exhaust manifold by at least one respective exhaust valve.

The intake manifold 1 receives fresh air (i.e. air from the external atmosphere containing approximately 20% oxygen) from an intake device (known and not shown) to which it is connected by a supply tube 2, and may receive a predetermined quantity of the exhaust gases contained in the exhaust manifold and generated by prior combustion in the cylinders via a recycling duct 3.

The intake manifold 1 comprises a tubular member 4 having an inner chamber 5 and four intake ducts 6 which extend parallel to and equally spaced from one another from the lateral surface of the tubular member 4 in order to bring the inner chamber 5 into communication with the respective cylinders. The supply tube 2 is connected at an inlet end of the tubular member 4 by means of the interposition of a butterfly valve 7 which is adapted to stop fresh air from entering the inner chamber 5 in particular operating conditions (typically when the engine is off).

The tubular member 4 is mechanically connected by means of a series of screws (known and not shown) to a support body 8 which is physically independent from the tubular member 4 and houses the recycling duct 3. In particular, the support body 8 is mechanically connected to the tubular member 4 so that it is disposed in the space bounded at the bottom by the intake ducts 6 and laterally by the tubular member 4.

The support body 8 is U-shaped with two rectilinear sections 9 and 10 connected by a curved section 11; the rectilinear inlet section 9 is disposed above the intake ducts 6, while the rectilinear output section 10 is disposed laterally and in the vicinity of the tubular member 4. An initial portion of the rectilinear inlet section 9 is connected to the exhaust manifold in order to receive the exhaust gases to be recycled, and an end portion of the rectilinear output section 10 is connected to the inner chamber 5 of the intake manifold 1 in order to introduce the recycled exhaust gases into this inner chamber 5.

The support body 8 comprises a recycling valve 12 which is adapted to regulate the flow of exhaust gas through the recycling duct 3 and is housed in an initial portion of the rectilinear inlet section 9 so as to be disposed at the location of an initial portion of the recycling duct 3.

The support body 8 further comprises a heat exchanger 13 which is adapted to cool the recycled exhaust gases and is housed along the rectilinear inlet section 9 downstream of the recycling valve 12. The heat exchanger 13 comprises a tube 14 folded into a U shape which forms an upper wall of the recycling duct 3 and in which an engine cooling fluid is caused to circulate.

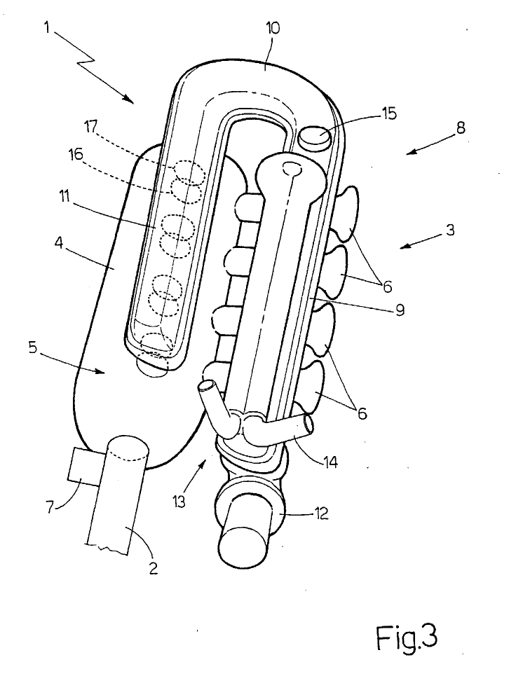

Lastly, the support body 8 comprises a flow sensor 15 which is adapted to measure the flow of recycled exhaust gases and is housed in a median portion of the rectilinear outlet section 10 downstream of the heat exchanger 13. According to the further embodiment shown in FIG. 3, the flow sensor 15 is housed in a final portion of the rectilinear inlet section 9 downstream of the heat exchanger 13.

It is important to note that the flow sensor 15 is preferably housed downstream of the heat exchanger 13, so as cause the flow sensor 15 to work at relatively low temperatures (of some 200° C. rather than the 400° C. of the exhaust gases from the exhaust manifold) and therefore contain the production costs of this flow sensor 15. Moreover, the flow sensor 15 is housed, along a rectilinear portion of the recycling duct 3 so as to allow the sensor 15 to carry out a measurement with a relatively high precision, as the measurement of a flow sensor is the more precise, the more remotely the flow sensor is positioned from non-rectilinear sections.

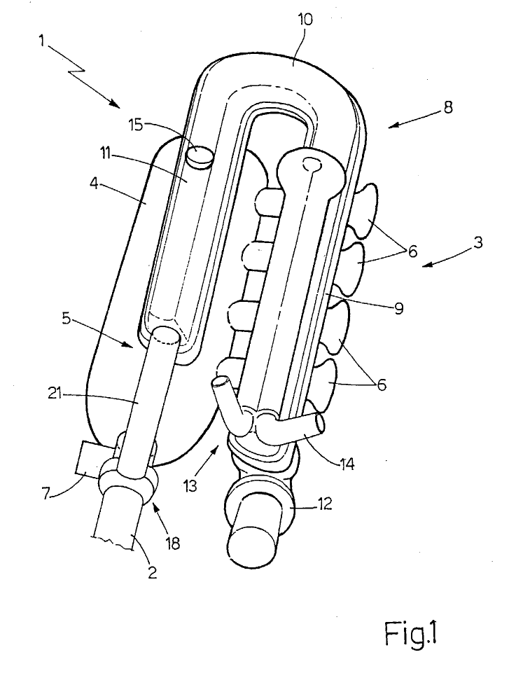

As shown in FIG. 1, the intake manifold 1 comprises a mixing device 18 which is disposed immediately upstream of the tubular member 4 along the supply tube 2, receives the recycled exhaust gases from the recycling duct 3 and receives fresh air from the intake tube 2.

According to the further embodiment shown in FIG. 3, the tubular member 4 comprises, for each intake duct 6, a respective through hole 16 which is provided in the vicinity of the corresponding intake duct 6 and brings the inner chamber 5 into communication with the recycling duct 3; similarly, the rectilinear output section 10 of the support body 8 has, for each through hole 16, a respective through hole 17 which is coupled to the corresponding through hole 16.

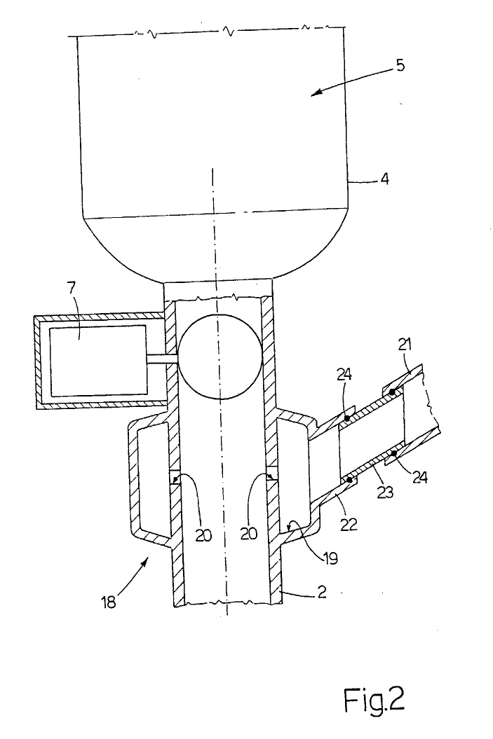

As shown in FIG. 2, the mixing device 18 comprises an annular chamber 19 which surrounds a portion of the supply tube 2, communicates with the supply tube 2 via a plurality of radial through holes 20 and receives the recycled exhaust gases from the recycling duct 3. In operation, the exhaust gases from the recycling duct 3 are conveyed to the annular chamber 19 at a pressure that is relatively higher than the intake pressure under the action of the relatively higher pressure in the exhaust manifold; as the fresh air in the supply tube 2 is substantially at atmospheric pressure, the exhaust gas in the annular chamber 19 enters the supply tube 2 via the radial through holes 20 and is mixed with the air from the intake line before entering the inner chamber 5 of the intake manifold 1.

An end tube 21 of the recycling duct 3 is coupled flush with an inlet tube 22 of the mixing device 18 by means of a further connection tube 23 which is coaxial to the end tube 21 and to the inlet tube 22 and is adapted internally to engage, in a fluid-tight manner, both the end tube 21 of the recycling duct 3 and the inlet tube 22 of the mixing device 18. Respective annular sealing members 24 of elastic material (commonly known as “O-rings”) are interposed between the connection tube 23 and the end tube 21 and inlet tube 22 so as to ensure the leak-tightness of the coupling and at the same time to allow a limited axial sliding between the connection tube 23 and the end tube 21 and inlet tube 22. This axial sliding is essential to compensate for any imbalances in the heat expansions to which the end tube 21 and inlet tube 22 are subject.

The mixing device 18 preferably comprises and integrates the butterfly valve 7 that regulates the intake of the gas mixture into the inner chamber 5 of the intake manifold 1; this integration makes it possible to reduce both the bulk and the overall costs of the intake manifold 1.

According to a possible embodiment, the support body 8 is made from metal material, in particular aluminium, as it has to provide adequate support for the recycling valve 12 and the heat exchanger 13 and has to operate with gases at relatively high temperatures (the exhaust gases from the exhaust manifold have a temperature of some 400° C.); the tubular member 4 is, however, of plastic material, which is light and can be readily moulded, since it operates with gases at relatively low temperatures (the mixture of fresh air and recycled exhaust gas does not exceed 100° C.).

According to a further embodiment (not shown), a bypass duct is provided in parallel with the heat exchanger 13; the passage of the exhaust gases to be recycled through the heat exchanger 13 or through the bypass duct is controlled by the recycling valve 12. In particular, the exhaust gases to be recycled are caused to pass through the bypass duct, thereby avoiding passing though the heat exchanger 13, on ignition of the engine and are subsequently caused to pass through the heat exchanger 13 when the engine has reached a minimum operating temperature threshold.

1. An intake manifold for an internal combustion engine provided with exhaust gas recycling, this intake manifold (1) comprising a tubular member (4) having an inner chamber (5), a plurality of intake ducts (6) which extend parallel to and equally spaced from one another from the lateral surface of the tubular member (4) in order to bring the inner chamber (5) into communication with respective cylinders, and a recycling duct (3) which is housed in a support body (8) and is adapted to receive the exhaust gases from an exhaust manifold so that these exhaust gases can be introduced into the inner chamber (5), the intake manifold (1) being characterised in that the support body (8) is physically independent from the tubular member (4) and is mechanically connected to the tubular member (4) so as to be disposed in the space bounded at the bottom by the intake ducts (6) and laterally by the tubular member (4).

2. An intake manifold as claimed in claim 1, in which the support body (8) is U-shaped with two rectilinear sections (9, 10) connected by a curved section (11), a first rectilinear section (9) being disposed above the intake ducts (6) and a second rectilinear section (10) being disposed laterally and in the vicinity of the tubular member (4).

3. An intake manifold as claimed in claim 1, in which the support body (8) comprises a recycling valve (12) adapted to regulate the flow of exhaust gases through the recycling duct (3).

4. An intake manifold as claimed in claim 3, in which the recycling valve (12) is housed at the location of an initial portion of the recycling duct (3).

5. An intake manifold as claimed in claim 1, in which the support body (8) comprises a heat exchanger (13) adapted to cool the recycled exhaust gases.

6. An intake manifold as claimed in claim 5, in which the heat exchanger (13) comprises a tube (14) folded into a U shape in which an engine cooling fluid is caused to flow.

7. An intake manifold as claimed in claim 5, in which the tube (14) folded into a U shape forms an upper wall of the recycling duct (3).

8. An intake manifold as claimed in claim 1, in which the support body (8) comprises a flow sensor (15) adapted to measure the flow of recycled exhaust gases.

9. An intake manifold as claimed in claim 2, in which an initial portion of the first rectilinear section (9) of the support body (8) is connected to the exhaust manifold in order to receive the exhaust gases to be recycled, and an end portion of the second rectilinear section (10) of the support body (8) is connected to the inner chamber (5) in order to introduce the recycled exhaust gases into this inner chamber (5).

10. An intake manifold as claimed in claim 9, in which the support body (8) comprises a recycling valve (12) adapted to regulate the flow of exhaust gases through the recycling duct (3), a heat exchanger (13) adapted to cool the recycled exhaust gases and a flow sensor (15) adapted to measure the flow of recycled exhaust gases, the recycling valve (12) being disposed in an initial portion of the first rectilinear section (9) of the support body (8), the heat exchanger (13) being disposed along the first rectilinear section (9) of the support body (8) downstream of the recycling valve (12) and the flow sensor (15) being disposed downstream of the heat exchanger (13).

11. An intake manifold as claimed in claim 10, in which the flow sensor (15) is disposed at the location of an end portion of the first rectilinear section (9) of the support body (8).

12. An intake manifold as claimed in claim 10, in which the flow sensor (15) is disposed at the location of a median portion of the second rectilinear section (10) of the support body (8).

13. An intake manifold as claimed in claim 10, and comprising a bypass duct in parallel with the heat exchanger (13) , the passage of the exhaust gases to be recycled through the heat exchanger (13) or through the bypass duct being controlled by the recycling valve (12).

14. An intake manifold as claimed in claim 1, in which the tubular member (4) has, for each intake duct (6), a respective first through hole (16), which is provided in the vicinity of the corresponding intake duct (6) and brings the inner chamber (5) into communication with the recycling duct (3).

15. An intake manifold as claimed in claim 14, in which the recycling duct (3) has, for each first through hole (16), a respective second through hole (17) which is coupled to the corresponding first through hole (16).

16. An intake manifold as claimed in claim 1, in which the intake manifold comprises a mixing device (18) which is disposed immediately upstream of the tubular member (4), receives the recycled exhaust gases from the recycling duct (3) and receives fresh air from an intake device.

17. An intake manifold as claimed in claim 16, in which the mixing device (18) has an annular chamber (19) and is disposed along a supply tube (2), which receives fresh air from the intake device and communicates with the inner chamber (5), the annular chamber (19) surrounding a portion of the supply tube (2), communicating with the supply tube (2) by means of a plurality (20) of radial through holes, and receiving the recycled exhaust gases from the recycling duct (3).

18. An intake manifold as claimed in claim 16, in which an end tube (21) of the recycling duct (3) is coupled flush with an inlet tube (22) of the mixing device (18) by means of a further connection tube (23) which is coaxial to the end tube (21) and the inlet tube (22) and is adapted internally to engage, in a fluid-tight manner, both the end tube (21) of the recycling duct (3) and the inlet tube (22) of the mixing device (18), axial sliding being possible between the connection tube (23) and the end tube (21) and inlet tube (22).

19. An intake manifold as claimed in claim 18, in which respective annular sealing members (24) of elastic material are interposed between the connection tube (23) and the end tube (21) and inlet tube (22).

20. An intake manifold as claimed in claim 16, in which the mixing device (18) comprises a butterfly valve (7) adapted to regulate the inlet of the gas mixture into the inner chamber (5).

21. An intake manifold as claimed in claim 1, in which the support body (8) is made from metal material, in particular aluminium, and the tubular member (4) is made from plastic material.
